(19) United States
(12) Patent Application Publication
(10) Pub. No.: US 2008/0234148 A1
(43) Pub. Date: Sep. 25, 2008

(54) Method of Increasing pH of High-Density Brines

(75) Inventor: Michael L. Walker, Sugar Land, TX (US)

Correspondence Address: MADAN, MOSSMAN & SRIRAM, P.C., 2603 AUGUSTA DRIVE, SUITE 700, HOUSTON, TX, 77057-5662, US

(73) Assignee: BAKER HUGHES INCORPORATED, HOUSTON, TX (US)

(21) Appl. No.: 12/134,057

(22) Filed: Jun. 5, 2008

Related U.S. Application Data
(63) Continuation-in-part of application No. 11/076,783, filed on Mar. 10, 2005.
Application No. 11/076,783 is a division of application No. 10/726,936, filed on Dec. 3, 2003, now Pat. No. 6,894,008.
Application No. 10/726,936 is a continuation-in-part of application No. 10/192,023, filed on Jul. 10, 2002, now abandoned.
(60) Provisional application No. 60/305,036, filed on Jul. 11, 2001.

(51) Int. Cl. C09K 8/528

(52) U.S. Cl. 507/272; 507/269; 507/276

(57) ABSTRACT

It has been discovered that carbonate powders and bicarbonate powders are useful to increase the pH and corrosion resistance of high-density brines, such as zinc bromide brines, without significantly reducing their densities. The carbonates and/or bicarbonates should be water-soluble and may be sodium, potassium, magnesium and/or ammonium carbonates and/or bicarbonates and the like. The carbonates and/or bicarbonates are easily added in powder or other finely divided solid form and are completely dissolved in the brine prior to pumping the brine into a subterranean formation.

### CROSS-REFERENCE TO RELATED APPLICATION

This application is a continuation-in-part of U.S. patent application Ser. No. 11/076,783, filed Mar. 10, 2005, which is a divisional of U.S. patent application Ser. No. 10/726,936 filed Dec. 3, 2003, issued May 17, 2005 as U.S. Pat. No. 6,894,008, which is a continuation-in-part of U.S. patent application Ser. No. 10/192,023 filed Jul. 10, 2002, now abandoned, which in turn claimed the benefit of U.S. Provisional Application No. 60/305,036 filed Jul. 11, 2001.

### TECHNICAL FIELD

The instant invention relates to brine fluids, such as those used in recovering hydrocarbons, and more particularly relates, in one embodiment, to high-density brine fluids with improved corrosion resistance.

### TECHNICAL BACKGROUND

High-density brine fluids are known to be applied in situations where control of pressure in a well is needed. Many different soluble salts may be used to achieve the desired density of the aqueous solution. The more common salts used include, but are not necessarily limited to, chloride and/or bromide salts of the following cations: sodium, potassium, calcium and zinc. These salts impart density to the aqueous fluid by dissolving in the medium. A high-density fluid may be understood as one of greater than about 8.4 pounds/gallon (1.0 kg/l) density, preferably from about 8.4 to about 22.5 lbs/gal. (1.0-2.7 kg/l), most preferably from about 9.0 to about 22.0 lbs/gal. (1.1-2.6 kg/l).

The density of these solutions made by dissolving these salts in water is limited by the molecular weight and the solubility of that salt. Zinc is a preferred cation. Zinc salts are desired as components of high-density brines because of their relatively high molecular weight and great solubility in water.

Brines, including zinc-containing brines, have low pH in aqueous solutions inherently. The acid content of these fluids give the brines undesirable characterized, one of the greatest of which are high corrosion losses that limit the uses and applications of these fluids.

A method and composition that would overcome some of the problems in the conventional brines, particularly high-density brines, would be desirable.

### SUMMARY

In carrying out these and other objects of the invention, there is provided, in one form, a method for increasing the corrosion resistance of a brine fluid in an operation to recover hydrocarbons from a subterranean formation. The process involves first providing a brine including water and at least one source of water-soluble cations to form a brine fluid with the water. The density of the brine fluid is at least 11 pounds/gal (1.3 kg/liter) where the cations include lithium, sodium, potassium, calcium, magnesium, zinc, ammonium, cesium, rare earths, and mixtures thereof. Next, all of an additive is completely dissolved in the brine, where the additive may be a water-soluble carbonate powder, water-soluble bicarbonate powder, and mixtures thereof. In one non-limiting embodiment, the cation of the carbonate or bicarbonate may be sodium, potassium, magnesium, ammonium and mixtures thereof. The carbonate or bicarbonate is present in an amount effective to raise the pH of and decrease the corrosion propensity of the brine. The additive may be in the form of a powder, and may be added at a controlled rate that forms no precipitate. The corrosion resistant brine fluid is pumped into a subterranean formation, where substantially all of the brine-soluble additive dissolves in the brine fluid prior to pumping. By “substantially all” is meant that at least 97 wt % of the additive dissolves, alternatively at least 99 wt % of the additive dissolves.

It will be appreciated that when it is noted that “substantially all” or a particular wt % of the additive dissolves in the brine that what dissolves is the active water-soluble or brine-soluble carbonate or bicarbonate powder. It should be recognized that there are a great variety of commercial carbonates and bicarbonates, most, if not all, of which contain fillers that may or may not dissolve in the methods herein. In a non-limiting example, up to 75 wt % of the commercial product may not dissolve, but nevertheless substantially all of the carbonate or bicarbonate powder does dissolve.

### DETAILED DESCRIPTION

The addition of a water-soluble carbonate and/or water-soluble bicarbonate to a high-density brine of sufficient salt content, e.g. zinc bromide, has been discovered to reduce the acidity of the zinc solution. The carbonates and/or bicarbonates are solid materials and are more conveniently and safely transported and added to the brines than are liquids or gases. Preferably, the additives herein are finely divided solids and/or powders. “Water-soluble” is defined herein as the dissolution of from about 0.1 wt. % to about 50 wt. % of the salt in question in water under ambient conditions. “Brine-soluble” has the same definition with respect to brines. The brines with which this invention is concerned are not saturated brines, and the methods and fluids herein concern pumping the corrosion resistant brine fluid into a subterranean formation, where all of the brine-soluble additive completely dissolves in the brine fluid prior to pumping. In one non-limiting embodiment, the methods herein do not include operations involving bridging agents where salts as bridging agents are added to saturated brines, or where the bridging agent is less than 10 wt % dissolved in the brine.

The additive powders as described herein have a broad size range of between about 5 to about 500 microns. A preferable lower threshold for the additive powders is 10 microns, a more preferable lower threshold is 104 microns (140 mesh), and a most preferable lower threshold is 178 microns (80 mesh). Conversely, a preferable upper threshold for the additive powders is 450 microns, a more preferable upper threshold is 400 microns (40 mesh), and a most preferable upper threshold is 250 microns (60 mesh). It has been surprisingly discovered that by introducing the carbonate/bicarbonate additive as a fine powder, particularly in a controlled manner, that no precipitate is formed. It is difficult, if not impossible to define what a “controlled manner” would exactly be since the rate of addition and mixing would depend on a number of factors, including, but not necessarily limited to, the density of the brine, the nature of the cation used to make the brine, the size and nature of the additive powders, the temperature of the brine, and the interrelations of these factors. However, it should be understood that all of the powder added is dissolved in the brine relatively quickly prior to pumping the brine into a subterranean formation. The additive powder is not intended to fall out as a precipitate or to be suspended, but is to dissolve completely and thoroughly.

One having ordinary skill in the art would normally expect the addition of the carbonate and/or bicarbonate in solid form to precipitate the brine forming cation. (For instance, in the non-limiting example of a zinc bromide brine, it would be expected that zinc oxide and/or other materials would precipitate). Without wishing to be bound by any one theory, it may be that the use of a powder prevents localized high concentrations of the carbonate and/or bicarbonate additive, where high localized concentrations would cause precipitation. In these brine systems, once precipitation occurs, it is very difficult to solubilize the precipitate again. High localized concentrations are believed to be the cause of precipitation when neutralizing liquid bases are used with these brines. In any case, it has been found that it is impossible to stir the high-density brines fast enough when a neutralizing base is added in liquid form.

Indeed, powders too small, e.g. below 5 microns in size, may dissolve sufficiently quickly to result in localized concentrations adequately high enough to cause precipitation, in one non-limiting embodiment. The use of powders has the additional advantage of not including an inert liquid solvent in the product that would add to shipping, storage and handling costs. However, a major disadvantage of using an inert liquid solvent is that when the product is added to the fluid, the inert liquid solvent lowers the density of the brine fluid, e.g. by dilution.

The treated brine fluids may include, but are not necessarily limited to packer fluids, completion fluids, workover fluids, and the like. These fluids are pumped downhole through a well bore in an operation to recover hydrocarbons from a subterranean formation. Any high-density brine containing salts that cause corrosion problems may be treated with the methods herein. The methods herein raise the pH of these fluids and thus lowers their acidity and improves or eliminates their corrosivities. In one non-limiting embodiment, the pH of the brine fluid is increased by at least 0.5 units, and in another non-restrictive version by at least 1.0 unit. Alternatively, the pH of the brine fluid is increased by at least 3.0 units. It may be understood that the corrosive nature of initial brine fluid is dependent on pH of that fluid, and that reduction of its corrosive nature is dependent on amount of acidity removed or reduced. Thus, a fluid with a high concentration of zinc (in a non-limiting instance, a 18.0 lb/gal (2.2 kg/L) brine) may have carbonate added to reduce the acidity to 3.0 from an initial value of 0.5. While a brine with a relatively low concentration of zinc (e.g. 12.0 lb/gal (1.4 kg/L) brine) may have acidity reduced to pH value of 6.0 from an initial pH value of 5.5. In both cases, the method is practiced.

The method is expected to be useful for any high-density fluid having a density of greater than about 8.4 pounds/gallon (1.0 kg/I), preferably from about 8.4 to about 22.5 lbs/gal (1.0-2.7 kg/I), most preferably from about 9.0 to about 22.0 lbs/gal (1.1-2.6 kg/I) and which has low pH, i.e., which is less than neutral. In one non-limiting embodiment of the invention, the density of the high density brine is at least about 11 lb/gal (1.3 kg/l). The salt in the water to make the brine may be a chloride, bromide, formate or acetate salt. The salt cations may be lithium, sodium, potassium, calcium, magnesium, zinc, ammonium, cesium, and rare earths. Mixtures of salts may also be employed. In fact, such mixtures are common. For instance, zinc salts are often mixed with calcium salts in a non-limiting embodiment, for commercial purposes to reduce the cost of using zinc salts. In one non-limiting embodiment, zinc sources are particularly suitable, and zinc chloride and zinc bromide are particularly suitable as zinc sources. Rare earths have their common definition of one or more of a group of 14 chemically related elements in row 6 of the Periodic Table ranging from lanthanum to ytterbium, inclusive. In one non-limiting embodiment of the method, the brine may include up to 35 wt. % potassium formate, and in an alternate embodiment from about 0.1 to about 30 wt. %.

The additive may be any suitable water-soluble carbonate or water-soluble bicarbonate or combination thereof that is effective in increasing the pH of the brines in question. In particular, the suitable carbonates and bicarbonates have lithium, sodium, potassium, cesium, magnesium and ammonium as the cations thereto. Carbonates and bicarbonates of different cations may be used together. It will also be appreciated that the carbonates as defined herein include double salts of hydroxides. Such double salts are particularly formed by alkaline earth metals, e.g. magnesium.

While not wishing to be limited to a particular mechanism or explanation of how the invention operates, the carbonates and bicarbonates may be understood as those that are capable of absorbing some of the acid. However, it should be clear that in this method it is the carbonate ion that is consuming the acid and not the cation, such as ammonium ion.

As noted, compounds such as lithium, sodium, potassium, cesium and/or ammonium carbonate and bicarbonates are solids that dissolve over a relatively short period of time. The addition of these additives to the brines causes the evolution of carbon dioxide gas (CO₂) that should generally be purged from the brine. In one non-limiting embodiment of the method, the carbonate and/or bicarbonate additive should be added to the brine just before the point at which precipitation of the zinc (or other salt metal) would occur. This precipitation is undesirable.

Also in a suitable, but non-limiting embodiment, the powdered additive is present in a concentration ranging from about 0.05 moles additive per mole of cation (e.g. Zn⁺⁺) to about 2.0 moles additive per mole of cation, in another suitable range from about 0.05 moles additive per mole of cation to about 1.5 moles additive per mole of cation. These ranges may be different for cations other than Zn⁺⁺. In another non-limiting embodiment of the method, the amount of additive is from about 0.1 to 10 wt. % based on the amount of water-soluble cation (e.g. zinc or other cation) in the brine. Alternatively, the amount of additive is from about 0.1 to about 5 wt. %, and in another non-restrictive version from about 0.1 to about 0.5 wt. %. Too much of any additive, such as ammonia, causes a precipitate, which is undesirable.

The greater the amount of additive added to the brine, the better the corrosion properties of the brine will be. However, increasing proportions of additive tends to decrease the stability of the brine. In some instances, as the concentration of additive approaches 1% w/w based on the total amount of brine, the solution may begin to precipitate depending upon a number of complex, interrelated factors. The degree of precipitation is directly proportional to the amount of additive added. This precipitation results in loss of density, which reduces its utility.

The lower acidity achieved by the method may result from simple acid-base neutralization, or may possibly arise from additive forming complexes with zinc (or other water-soluble cation) suppressing the hydrolysis of the complexed water molecules. However, it will be understood that the method is not limited to any particular explanation of the mechanism by which it might work.

The method is useful to inhibit the corrosion of iron-based metals and alloys such as steels. The method would also be expected to be effective in inhibiting the corrosion of low alloy steels, carbon steels, stainless steels, nickel-based alloys, and the like. The corrosion of copper alloys may also be inhibited by the compositions and methods herein, but there is a possibility that nitrogen-containing materials may cause undesired cracking in copper alloys.

Using the compositions and methods described, corrosion rates with N-80 steel may be reduced by two orders of magnitude and more in comparison with corrosion rates in conventional zinc-based brine of the same density. It is further expected that the thermal stability of viscosifiers in zinc-brine-based brines should be enhanced significantly. Suitable viscosifiers include, but are not necessarily limited to, for example, polysaccharides and viscoelastic surfactants. Low pH brines react with the polysaccharide by acid hydrolysis of the polymer linkages, which thus undesirably reduces the viscosity and stability of the fluid.

Conventional drilling and/or completion fluid additives may, of course, be employed in the brine fluids herein, including, but not necessarily limited to, wetting agents, viscosifiers, suspending agents, weighting agents, shale stabilizers, filtration control additives, anti-balling additives, lubricants, seepage control additives, lost circulation additives, corrosion inhibitors, thinners, dispersants, non-emulsifiers or demulsifiers, and the like. In other non-limiting embodiments, there are certain components that may be omitted from the brine fluids, that is, the brine fluids has an absence of these components which are of lesser importance, irrelevant or inapplicable to the method or possibly deleterious in certain applications or circumstances. These less important, inert or perhaps deleterious components include viscosifiers (including high area silica and biopolymers such as hydroxyethyl cellulose), suspension additives, polar additives, bridging agents, dissolved carbon dioxide (CO₂) and proppants. The brine fluids may have an absence of one or more of these. Polar additives include additives having a molecular weight less than about 400 and containing one or more polar groups per molecule such as hydroxyl, amino, and combinations thereof.

Optionally, one or more conventional corrosion inhibitors may be used in the brines to further improve their corrosion properties. In another non-limiting embodiment, the additives are used in the absence of other, added corrosion inhibitors, particularly phosphate, nitrite and/or amine corrosion inhibitors. For yet another non-limiting embodiment, the additives are used in the absence of an added Group VB metal (previous IUPAC notation), and particularly in the absence of added arsenic.

As previously noted, in one non-restrictive embodiment, the brine fluids will find application in the recovering of hydrocarbons, such as in situations where control of pressure in a well is needed, in one non-limiting embodiment. These brine fluids must meet certain other specifications and parameters that do not apply to brine fluids in general. For instance, high density brine fluids must have an acceptable true crystallization temperature (TCT) and an acceptable last crystal to dissolve (LCTD) temperature.

The TCT is a thermodynamic property that is the point at which crystals are formed at equilibrium. The LCTD temperature is a physical property reflecting the temperature at which the last crystal disappears. Both of these parameters are particularly important for high density brines that are used in offshore drilling where the brine is subjected to the relatively cold region of the sea water before the brine is pumped downhole. Both the TCT and the LCTD points are defined by the composition of the brine, not the density of the fluid. Fluids with the same density can have different TCT and LCTD values.

For instance, the following two fluids have the same density and specific gravity, but quite different TCT and LCTD points:

| | Fluid A - 3 salt mixture | Fluid B - 2 salt mixture |
|---|---|---|
| Density, lb/gal | 18 | 18 |
| Specific gravity | 2.161 | 2.161 |
| CaCl₂, wt % | 4.91 | — |
| CaBr₂, wt % | 27.9 | 23.8 |
| ZnBr₂, wt % | 39.8 | 42.8 |
| TCT, ° F. | 35 | −2 |
| LCTD, ° F. | 47 | −15 |

In one non-limiting embodiment, the corrosion resistant, high-density brines containing at least three salts, in a non-limiting example CaCl₂, CaBr₂ and ZnBr₂, have a TCT that ranges between about 80 to about 0° F., and in an alternate embodiment ranges between about 70 to about 5° F., and in still another non-limiting embodiment ranges between about 60 to about 10° F. Although the LCTD may fall into these same ranges for 3-salt brines, it will be appreciated, particularly from the above Fluids A and B, that the TCT and LCTD are not the same, and are in fact rarely the same. For high-density brines containing at least two salts, in a non-limiting example CaBr₂ and ZnBr₂, they may have a TCT that ranges between about −70 to about 20° F., and in an alternate embodiment ranges between about −65 to about 15° F. Again, the LCTD may fall into these same ranges for 2-salt brines, but is not necessarily the same value as the TCT.

The invention is further illustrated by the following Examples, which are only meant to further illuminate the invention and not limit it in any way.

### EXAMPLES 1-2

Brine solutions containing various amounts of soluble sodium carbonates or bicarbonates were prepared. These solutions were prepared by vigorously stirring a high-density brine solution to which had been added a powdered carbonate or bicarbonate. The resultant solution is purged with nitrogen to remove dissolved carbon dioxide gas. The resultant solutions were tested at 350° F. (177° C.) for 24 hours on N-80 tubing steel, as shown in Table I.

TABLE I
Raising pH and Corrosion Resistance Using Sodium Bicarbonate

| | | | | | Corrosion |
|---|---|---|---|---|---|
| | Initial | | | | losses, |
| | fluid density, | | | Resultant density, | lbs/ft² |
| Ex. | lb/gal (kg/m³) | pH¹ | Additive | lb/gal (kg/m³) | (kg/m²) |
| 1 | 19.7 (2.36 × 10³) | 5.87 | None | 19.7 (2.36 × 10³) | 0.067 |
| | | | | | (0.33) |
| 2 | 19.7 (2.36 × 10³) | 6.70 | DKI-13² | 19.6 (2.35 × 10³) | 0.030 |
| | | | | | (0.15) |

¹pH was determined in a 1 to 100 diluted solution of the brine in distilled water.
²DKI-13 is sodium bicarbonate in powder form.

It will be appreciated that using the indicated level of additive in accordance with the methods herein that the corrosion rate of the high-density brine of these Examples was reduced by about half.

A method has thus been demonstrated to raise the pH of high-density brines, and thus raise their corrosion resistance. The high-density brines have also had their pH raised and corrosion resistance improved through employing readily available agents.

In the foregoing specification, the invention has been described with reference to specific embodiments thereof, and has been demonstrated as effective in providing brine fluids having increased pH and corrosion resistance with little decrease in density. However, it will be evident that various modifications and changes can be made thereto without departing from the broader spirit or scope of the invention as set forth in the appended claims. Accordingly, the specification is to be regarded in an illustrative rather than a restrictive sense. For example, specific combinations of brines, specifically salts and additives, in other proportions or added in different ways, falling within the claimed parameters, but not specifically identified or tried in a particular composition to improve the brines herein, are anticipated to be within the scope of this invention. Further, highly porous granules of carbonates and bicarbonates with relatively large surface areas that dissolve at the same rates as the powders described herein are also within the scope of this invention, even though their nominal diameters may be outside some of the ranges described.

The present invention may suitably comprise, consist or consist essentially of the elements disclosed and may be practiced in the absence of an element not disclosed.

The words “comprising” and “comprises” as used throughout the claims is to interpreted “including but not limited to”.

What is claimed is:

1. A method for increasing the corrosion resistance of a brine fluid in an operation to recover hydrocarbons from a subterranean formation comprising:
providing a brine fluid comprising:
water;
at least one source of water-soluble zinc cations to form a brine fluid with the water, where the density of the brine fluid is at least 11 pounds/gal (1.3 kg/liter), where the brine fluid is not a saturated brine fluid;
dissolving in the brine fluid all of a brine-soluble additive selected from the group consisting of water-soluble carbonates, water-soluble bicarbonates, and mixtures thereof where the additive is in the form of a powder and in an amount effective to increase the pH of the brine fluid and at a controlled rate that forms no precipitate, to give a corrosion resistant brine fluid; and
pumping the corrosion resistant brine fluid into a subterranean formation, where substantially all of the brine-soluble additive dissolves in the brine fluid prior to pumping.

2. The method of claim 1 where the additive has a cation selected from the group consisting of lithium, sodium, potassium, cesium magnesium, ammonium and mixtures thereof.

3. The method of claim 1 where the pH of the brine fluid is increased by at least 0.5 units.

4. The method of claim 1 where the source of water-soluble zinc cations is at least one salt selected from the group consisting of chloride, bromide, acetate, and formate salts.

5. The method of claim 1 where the source of water-soluble zinc cations is selected from the group consisting of zinc chloride and zinc bromide.

6. The method of claim 1 where the additive is selected from the group consisting of sodium carbonate, sodium bicarbonate, and mixtures thereof.

7. The method of claim 1 where the additive is present in a mole ratio to the total amount of water-soluble cation ranging from about 0.05/1 to about 2.0/1.

8. The method of claim 1 where the additive is present in an amount from 0.1 to 10 wt. % based on the total amount of water-soluble cation.

9. The method of claim 1 where the additive powder ranges in size from about 5 to about 500 microns.

10. The method of claim 1 further comprising adding at least one non-emulsifier and at least one wetting agent.

11. The method of claim 1 where the corrosion resistant brine fluid has a plurality of different sources of water-soluble cations selected from the group consisting of two or three,
where in the case there are at least two different sources of water-soluble cations the true crystallization temperature (TCT) and the last crystal to dissolve (LCTD) temperature independently range between about −70 to about 20° F., and
where in the case there are at least three different sources of water-soluble cations the true crystallization temperature (TCT) and the last crystal to dissolve (LCTD) temperature independently range between about 80 to about 0° F.

12. The method of claim 11 where in the case there are two different sources of water-soluble cations, the sources are zinc bromide and calcium bromide, and in the case there are three different sources of water-soluble cations, the sources are zinc bromide, calcium chloride and calcium bromide.

13. The method of claim 1 further comprising contacting the brine fluid with iron-based metals or alloys and where a corrosion rate of the metals and alloys is reduced as compared with an identical brine fluid absent the additive.

14. A method for increasing the corrosion resistance of a brine fluid in an operation to recover hydrocarbons from a subterranean formation comprising:
providing a brine fluid comprising:
water;
at least one source of water-soluble zinc cations to form a brine fluid with the water, where the density of the brine fluid is at least 11 pounds/gal (1.3 kg/liter), and where the brine fluid is not a saturated brine fluid; and
dissolving in the brine fluid all of a brine-soluble additive selected from the group consisting of water-soluble carbonates, water-soluble bicarbonates, and mixtures thereof where the additive is in the form of a powder and in an amount effective to increase the pH of the brine and at a controlled rate that forms no precipitate, to give a corrosion resistant brine fluid, and where the additive has a cation selected from the group consisting of sodium, potassium, magnesium, ammonium and mixtures thereof; and
pumping the corrosion resistant brine fluid into a subterranean formation, where substantially all of the brine-soluble additive dissolves in the brine fluid prior to pumping.

15. The method of claim 14 where the source of water-soluble zinc cations is at least one salt selected from the group consisting of chloride, bromide, acetate, and formate salts.

16. The method of claim 14 where the additive is selected from the group consisting of sodium carbonate, sodium bicarbonate, and mixtures thereof.

17. The method of claim 14 where the additive is present in a mole ratio to the total amount of water-soluble cation ranging from about 0.05/1 to about 2.0/1.

18. The method of claim 14 where the additive is present in an amount from 0.1 to 10 wt. % based on the total amount of water-soluble cation.

19. The method of claim 14 where the additive powder ranges in size from about 5 to about 500 microns.

20. The method of claim 14 further comprising adding at least one non-emulsifier and at least one wetting agent.

21. The method of claim 14 where the pH of the brine fluid is increased by at least 0.5 units.
